(19) United States
(12) Patent Application Publication
(10) Pub. No.: US 2025/0012907 A1
(43) Pub. Date: Jan. 9, 2025

(54) LIDAR SYSTEM

(71) Applicant: ams-OSRAM lnternational GmbH, Regensburg (DE)

(72) Inventor: Farhang GHASEMI AFSHAR, Wenzenbach (DE)

(21) Appl. No.: 18/695,343

(22) PCT Filed: Sep. 28, 2022
(86) PCT No.: PCT/EP2022/077041

§ 371 Date: Mar. 25, 2024

(30) Foreign Application Priority Data
Sep. 28, 2021 (DE) 10 2021 125 131.1

(51) Int. Cl. G01S 7/4915; G01B 11/22; G01S 7/481; G01S 7/4865; G01S 17/931

(52) U.S. Cl. CPC G01S 7/4915; G01B 11/22; G01S 7/4815; G01S 7/4816; G01S 7/4865; G01S 17/931

(57) ABSTRACT

A lidar system for surroundings detection includes an emitter for radiation emission and a detector for radiation detection. The emitter includes a plurality of separately controllable light sources for emitting light radiation. The lidar system is configured to operate the emitter in such a way that joint radiation operation is performed by a light source group comprising a plurality of light sources. The joint radiation operation of the light source group includes a continuous operating mode in which the light sources of the light source group emit differently modulated light radiations with different modulation frequencies. The detector is realized in the form of a single detector including only one radiation-sensitive detector structure.

The present invention relates to a lidar system for surroundings detection and a method for operating a lidar system.

This patent application claims the priority of German patent application 10 2021 125 131.1, the disclosure content of which is hereby incorporated by reference.

A lidar system (light detection and ranging), with the aid of which surroundings may be optically scanned and detected, may comprise an emitter for generating light radiation and a detector for radiation detection. During operation, the light radiation emitted by the emitter may be reflected at an object and detected by the detector. The distance of the object may be determined on the basis of this.

Known lidar systems may be configured according to two basic concepts. In the case of a scanning system, the light radiation may be directed at different times into different solid angles or solid angle ranges of a target region to be observed. In the case of a flash system, by contrast, simultaneous illumination of a target region may be effected. In order to obtain information about different solid angle ranges in this case, an addressable detector comprising a plurality of detector elements or radiation-sensitive pixels may be used. The pixels may be realized in the form of photodiodes such as avalanche photodiodes (APDs) or single-photon avalanche diodes (SPADs). A two-dimensional pixel arrangement is furthermore possible.

In order that a target region may be detected by a flash lidar system with high resolution, it is accordingly necessary to use a high-resolution detector comprising a large number of pixels. However, a high-resolution detector on the basis of avalanche photodiodes or single-photon avalanche diodes has not been commercially available heretofore. This is owing to costly and complex production. In this case, it proves to be difficult to configure the photodiodes with corresponding properties. Furthermore, each diode requires a dedicated amplifier circuit, as a result of which a readout circuit becomes increasingly more complex as the number of pixels increases. Moreover, crosstalk between adjacent photodiodes may occur in the case of a close-packed pixel arrangement.

The object of the present invention consists in specifying a solution for an improved lidar system.

This object is achieved by the features of the independent patent claims. Further advantageous embodiments of the invention are specified in the dependent claims.

In accordance with one aspect of the invention, a lidar system for surroundings detection is proposed. The lidar system comprises an emitter for radiation emission and a detector for radiation detection. The emitter comprises a plurality of separately controllable light sources for emitting light radiation. The lidar system is configured to operate the emitter in such a way that joint radiation operation is performed by a light source group comprising a plurality of light sources. The joint radiation operation of the light source group comprises a continuous operating mode, in which the light sources of the light source group emit differently modulated light radiations with different modulation frequencies.

The proposed lidar system comprises an emitter comprising a plurality of light sources which may be controlled separately, and which may thereby generate and emit light radiation separately and independently of one another. The light radiations generated by the individual light sources may be emitted into different sub-regions or solid angle ranges of a target region to be detected.

During operation of the lidar system, joint radiation generation is performed by a light source group comprising a plurality of light sources of the emitter. In this case, a continuous operating mode is used, in which the light sources of the light source group jointly emit differently modulated light radiations with modulation frequencies that differ from one another. In this case, light may be emitted by the light sources in a continuous manner and for a predefined time duration. The continuous operating mode may also be referred to as a continuous wave mode or CW mode. The presence of the different modulation frequencies is applicable in relation to the individual light sources of the light source group.

In the continuous operating mode, the light sources of the light source group may emit light radiation with a modulated or periodically modulated intensity, for example in the form of a sine or cosine curve. The light emission with a periodically changing intensity is effected with a corresponding modulation frequency. Each of the light sources of the light source group emits its light radiation with a dedicated modulation frequency that differs from the modulation frequencies of the other light sources.

In the case of back-reflection or backscattering that may take place at an object illuminated by the emitter, the modulated light radiations or at least a part of the modulated light radiations may be detected with the aid of the detector. The detector may thereupon generate a corresponding detector signal. On account of the different modulation frequencies, it is possible for the modulated light radiations reproduced by the detector signal to be differentiated from one another. An evaluation may therefore obtain spatial information in regard to the individual modulated light radiations, and hence about different solid angle ranges.

This approach means that there is no need to use a detector comprising a plurality of detector elements or radiation-sensitive pixels, nor even a high-resolution addressable detector. Instead, a relatively simply constructed and hence cost-effective detector may be used in the case of the lidar system. Said detector may be realized in the form of a single detector comprising only one radiation-sensitive detector structure. Moreover, the detector or its detector structure may be realized with a large surface area. This may foster detection of a back-reflected or backscattered radiation portion by the detector, and thus the system performance. In this case, the use of the emitter constructed from a plurality of light sources makes it possible to be able to optically detect a target region with a high resolution.

Further possible details and embodiments which may be considered for the lidar system are described in greater detail below.

The light sources of the emitter may be laser light sources. In one possible embodiment, the light sources are configured in the form of surface emitters (VCSEL, vertical-cavity surface-emitting laser). In this configuration, the emitter may comprise a laser component comprising the laser light sources or surface emitters. The laser component may be realized in the form of a semiconductor chip or laser chip.

The light sources may be arranged next to one another, for example in matrix-like fashion in the form of rows and columns. Furthermore, the light radiation emitted by the light sources may be light radiation in the infrared range or near infrared range.

The lidar system or its emitter may furthermore comprise imaging optics disposed downstream of the light sources. The imaging optics enable the light radiations generated by the light sources to be emitted into different solid angles, whereby different solid angle ranges of a target region of interest may be illuminated. In this case, the illumination of the target region may be effected in the form of a raster or grid.

With the aid of the detector used for radiation detection, a detector signal may be generated, with the aid of which a back-reflected radiation portion may be reproduced. The detector signal may be an electrical signal such as a voltage signal or a current signal. The detector, as indicated above, may be constructed relatively simply and may be configured in the form of a single detector. In one possible embodiment, the detector comprises a single photodiode such as, for example, a single avalanche photodiode.

Optics or receiving optics may correspondingly be used with regard to the detector. With the aid of the receiving optics, a back-reflected radiation portion may be collected and directed onto a radiation-sensitive detector structure such as a photodiode.

In a further embodiment, the lidar system comprises a control device. The operation of the emitter and of the light sources thereof for generating radiation may be controlled with the aid of the control device. The control device may furthermore be employed for the processing or evaluation of a detector signal generated by the detector in the case of a back-reflection. One or more items of information such as, for example, distance information may be provided as the result of the evaluation. Configurations of the lidar system which are described above and below and which concern the control of the emitter and an evaluation on the basis of a detector signal may be implemented with the aid of the control device.

In a further embodiment, the modulation frequencies with which the modulated light radiations are emitted by the light sources of the light source group in the continuous operating mode are in the MHz range. They may be multi-digit MHz frequencies.

In the case of a back-reflection or backscattering, at least a part of the differently modulated light radiations (i.e. at least one of the differently modulated light radiations) may be detected with the aid of the detector, and the detector may thereupon generate a detector signal. The detector signal may, according to the modulated light radiations, be a modulated detector signal. In this case, the detector signal may comprise a changing or modulated amplitude. The modulated detector signal may be formed by a superimposition of the detected and differently modulated light radiations, and may accordingly reproduce a superimposition of the detected and differently modulated light radiations. The lidar system in this context in accordance with a further embodiment is configured, on the basis of the modulated detector signal, to provide at least one item of phase information and, on the basis thereof, distance information.

The aforementioned embodiment may be based on the application of an indirect time of flight (indirect TOF) measurement. The phase information may be a phase shift between emitted and back-reflected modulated light radiation. The phase shift may be dependent on the path distance covered by the light radiation, and thus on the distance of an object at which the light radiation may be reflected back. Therefore, information about the distance of the object, and in this respect distance information, may be obtained by way of an evaluation on the basis of the phase shift. The phase angle of the emitted modulated light radiation to which the phase information or phase shift is related may be known for example on the basis of the operation or control of the light source that emits the light radiation.

With regard to the aforementioned embodiment, phase information and associated distance information may be provided for a plurality or each of the detected back-reflected and differently modulated light radiations. This is possible on account of the different modulation frequencies, whereby a separation in regard to the differently modulated light radiations may be attained during an evaluation. As has been indicated above, the light radiations of the light sources of the emitter may be emitted into different solid angle ranges of a target region. Accordingly, the use of the differently modulated light radiations affords the possibility of providing dedicated phase information and distance information in each case for different solid angle ranges.

The following configurations may be employed for bringing about a separation in regard to the differently modulated light radiations.

In a further embodiment, the lidar system is configured to carry out the provision of the phase information by way of applying a Fourier transform of the modulated detector signal. This may involve a fast Fourier transform (FFT). Carrying out the Fourier transform enables the modulated detector signal to be decomposed or divided into different frequency components, which makes it possible for light radiation emitted and back-reflected with a modulation frequency to be considered and evaluated separately, and for the phase information associated with the relevant light radiation to be provided. By way of applying the Fourier transform, furthermore, a plurality or all of the detected back-reflected and differently modulated light radiations may be evaluated separately, and corresponding phase information and, on the basis thereof, distance information may thus be made available for a plurality or each of the detected back-reflected and differently modulated light radiations.

The Fourier transform of the modulated detector signal may be performed with the aid of an analyzer or FFT analyzer. In this embodiment, the control device of the lidar system used for the evaluation may comprise such an analyzer for carrying out the Fourier transform.

In a further embodiment, the lidar system is configured to carry out the provision of the phase information by way of applying a frequency filtering of the modulated detector signal. In this case, by way of the detector signal being subjected to filtering or bandpass filtering tuned to a modulation frequency, light radiation emitted and back-reflected with this modulation frequency may be considered and evaluated separately, whereby phase information associated with the relevant light radiation may be provided. Frequency-tuned filtering of the detector signal may furthermore be used in regard to a plurality or all of the detected back-reflected and differently modulated light radiations, whereby these light radiations may be evaluated separately, and corresponding phase information and, on the basis thereof, distance information may be made available in each case with respect to the individual light radiations.

The frequency filtering of the modulated detector signal may be performed with the aid of filters or bandpass filters tuned to the modulation frequencies. In this embodiment, the control device of the lidar system used for the evaluation may comprise such a filter with regard to each of the modulation frequencies used.

The above-described indirect approach of ascertaining distance information on the basis of phase information or a phase shift between emitted and back-reflected modulated light radiation may be subject to an ambiguity on account of the periodicity of the modulated light radiation. In this case, the phase information provided may be appropriate to different distance values. In order to provide distance information in an unambiguous manner on the basis of phase information, the following configurations may be employed.

In a further embodiment, the joint radiation operation of the light source group comprises a pulsed operating mode, in which the light sources of the light source group emit light radiations in the form of at least one common pulse. The light sources of the light source group may emit the light radiations also in the form of a plurality of successive common pulses. In this way, it is possible to achieve an improvement in the signal-to-noise ratio (SNR) for an evaluation relating to the pulsed operating mode.

In the case of a back-reflection or backscattering, at least a part of the light radiations emitted in the form of a common pulse (i.e. at least one of these light radiations) may be detected with the aid of the detector, and the detector, according to the light radiations emitted in pulsed fashion, may thereupon generate a pulsed detector signal. The pulsed detector signal may be formed by a superimposition of the detected light radiations emitted in pulsed fashion, and may accordingly reproduce a superimposition of the detected light radiations emitted in pulsed fashion. The lidar system in this context in accordance with a further embodiment is configured, on the basis of the pulsed detector signal, to provide reference distance information or reference distance information and depth information.

With regard to the reference distance information, the lidar system may be configured to carry out the provision of the reference distance information on the basis of a time of flight of the light radiations emitted in the form of a pulse and at least partly reflected back. This embodiment may be based on the use of a direct time of flight (direct TOF) measurement. On the basis of the pulsed detector signal, i.e. the temporal occurrence of the pulsed detector signal with respect to the pulsed emission of the light radiations, a time of flight of the light radiations emitted in pulsed fashion and reflected back may be ascertained. The time of flight may be dependent on the path distance covered by the light radiations, and thus on the distance of an object at which the light radiations may be reflected back. Therefore, information about the distance of the object, and in this respect distance information, may be obtained on the basis of the pulsed detector signal and the time of flight determined according thereto. The distance information which is ascertained on the basis of the pulsed detector signal and which may be used as a reference for a comparison is referred to as reference distance information in the present case.

Depending on the configuration of the object or a surface region of the object which may be irradiated by the light radiations emitted in the form of a common pulse and at which the back-reflection may take place, there is the possibility of the back-reflected light radiations reaching the detector at different points in time and thus comprising different delay times or times of flight. The pulsed detector signal may therefore comprise a signal waveform and pulse width predefined by the respective configuration of the object. Accordingly, it is possible, on the basis of the pulsed detector signal, furthermore to obtain information about a depth extent of the object in the irradiated surface region, and in this respect depth information. The lidar system in this context in accordance with a further embodiment is configured to carry out the provision of the depth information on the basis of the pulse width of the pulsed detector signal.

If different times of flight are present, for example the smallest distance associated with the shortest time of flight may be employed as reference distance information. It is also possible to establish an average distance obtained by averaging.

As has been indicated above, the pulsed operating mode may be effected in such a way that the light sources of the light source group emit light radiations in the form of a plurality of successive common pulses. Accordingly, on the basis thereof, the detector may generate a plurality of pulsed detector signals successively. In this configuration, the reference distance information or the reference distance information together with the depth information may be provided on the basis of the plurality of pulsed detector signals. In this case, the associated evaluation may comprise summing the pulsed detector signals and ascertaining the reference distance information and optionally the depth information using the summed detector signals. This procedure makes it possible to improve the signal-to-noise ratio.

The emission of the light radiations in the form of a plurality of successive pulses may be effected at time intervals such that the light radiations associated with the individual pulses may be detected separately, and as a result separate pulsed detector signals may be generated by the detector. The time intervals may be chosen in this case taking into account a predefined maximum depth extent of an object in an irradiation region that is illuminable by the light source group.

In a further embodiment, the lidar system is configured to carry out the above-explained provision—performed on the basis of phase information—of the distance information, which is effected using the differently modulated light radiations as described above with reference to the continuous operating mode, additionally taking account of the reference distance information or taking account of the reference distance information and the depth information. This makes use of the fact that the reference distance information and the depth information may be unambiguous on account of the direct approach used to determine them. In this way, the reference distance information and the depth information may be used for comparing distance information obtained indirectly on the basis of phase information and subject to an ambiguity, with the result that the distance information may be provided unambiguously.

As has been indicated above, phase information and associated distance information may be provided for a plurality or each of the detected back-reflected and differently modulated light radiations. Accordingly, the provision of the plurality of items of distance information may be performed in each case taking account of the reference distance information or taking account of the reference distance information and the depth information.

With regard to the joint radiation operation of the light source group, there is the possibility of operating the light sources in the pulsed operating mode and afterward in the continuous operating mode. The reference distance information obtained on the basis of a (at least one) pulsed detector signal may relate to the light radiations emitted in pulsed fashion by a plurality or all of the light sources of the light source group, and thus to an irradiation region comprising a plurality of solid angle ranges. By contrast, distance information obtained on the basis of a continuous detector signal (and compared by way of the reference distance information and optionally the depth information) may relate to modulated light radiation emitted by one light source of the light source group, and thus to an individual solid angle range.

In the case of the lidar system, the use of the emitter constructed from a plurality of light sources affords the possibility of optically scanning a target region with a high resolution. As has been indicated above, the lidar system pursues the approach of obtaining information with regard to individual solid angle ranges of the target region with the aid of modulated light radiations used jointly and thereby simultaneously for illuminating a plurality of solid angle ranges. The light radiations are modulated differently from one another with different modulation frequencies, such that during an evaluation of a modulated detector signal generated by the detector, a separation in regard to the individual light radiations may be attained, and spatial information concerning individual solid angle ranges may be provided as a result. High-resolution scanning of the target region may be realized by virtue of the emitter comprising a large number of light sources. A reliable separation in the context of the evaluation may be achieved in this case as follows.

In a further embodiment, the lidar system is configured to operate the emitter in such a way that joint radiation operation is performed in each case successively by different light source groups comprising a plurality of light sources. In this case, the joint radiation operation comprises a continuous operating mode or a continuous operating mode and a pulsed operating mode. In the continuous operating mode the light sources of the respective light source group emit differently modulated light radiations with different modulation frequencies. In the pulsed operating mode the light sources of the respective light source group emit light radiations in the form of at least one common pulse.

With regard to the aforementioned embodiment, configurations and details such as have been mentioned above with respect to the joint radiation operation of one light source group may be correspondingly applied to the plurality of light source groups that are operated successively in each case in the joint radiation operation. In this case, on the basis of the with the detector in the case of a back-reflection that occurs in the radiation operation of at least one or a plurality or all of the light source groups, reference distance information and optionally depth information may be provided for each light source group, and furthermore a plurality of items of distance information relating to different spatial points or solid angle ranges may be provided for each light source group. In this way, with the light sources of the emitter, different solid angle ranges of a target region may be scanned, and different spatial points of a back-reflecting object may be detected as a result.

The aforementioned approach makes it possible to use an emitter with a large number of light sources. The number of light sources may be in the five-digit range, for example. By contrast, the number of light sources for each light source group, and thus the number of different modulation frequencies used in the continuous operating mode, may be significantly smaller, and may be in the two-digit range, for example. In this way, the modulation frequencies may be chosen such that a reliable separation in regard to the differently modulated light radiations is possible during an evaluation. In the continuous operating mode, the same different modulation frequencies may be employed in each case for the different light source groups.

With regard to the aforementioned embodiment, the successive joint radiation operation of the different light source groups may take place proceeding from a first light source group up to a last light source group of the emitter. In this way, items of information concerning different solid angle ranges of a target region may be obtained successively, and an image representation or three-dimensional image representation, for example in the form of a point cloud, of the target region with a high resolution may be provided progressively. In this case, the target region of interest may be optically scanned step by step in the form of a high-resolution raster. During operation of the lidar system, this process may be carried out a number of times successively with a predefined repetition frequency.

In accordance with a further aspect of the invention, a method for operating a lidar system is proposed. The lidar system comprises an emitter for radiation emission and a detector for radiation detection. The emitter comprises a plurality of separately controllable light sources for emitting light radiation. The emitter is operated in such a way that joint radiation operation is performed by a light source group comprising a plurality of light sources. The joint radiation operation of the light source group comprises a continuous operating mode, in which the light sources of the light source group emit differently modulated light radiations with different modulation frequencies.

For the method, the same features, details and embodiments may be applied and the same advantages may be conceivable such as have been explained above with regard to the lidar system. On account of the different modulation frequencies, the modulated light radiations may be differentiated from one another in the context of an evaluation of a detector signal generated by the detector, with the result that spatial information with regard to different solid angle ranges of a target region that are illuminated by the light sources may be obtained. The detector used may be a simply constructed detector in this case.

In one embodiment, in the case of a back-reflection at least a part of the differently modulated light radiations is detected with the aid of the detector and on the basis thereof a modulated detector signal is generated by the detector. On the basis of the modulated detector signal at least one item of phase information and, on the basis thereof, distance information are provided. The phase information may be a phase shift between emitted and back-reflected modulated light radiation and may depend on the distance of an object at which the light radiation may be reflected back. It is possible to provide phase information and associated distance information for a plurality or each of the detected back-reflected and differently modulated light radiations. The provision of the phase information (items) may be carried out by way of applying a Fourier transform or a frequency filtering of the modulated detector signal.

In a further embodiment, the joint radiation operation of the light source group comprises a pulsed operating mode, in which the light sources of the light source group emit light radiations in the form of at least one common pulse. Emission of light radiations by the light sources of the light source group may also be effected in the form of a plurality of successive common pulses.

In a further embodiment, in the case of a back-reflection at least a part of the light radiations emitted in the form of a pulse is detected with the aid of the detector and on the basis thereof a pulsed detector signal is generated by the detector. On the basis of the pulsed detector signal, reference distance information or reference distance information and depth information is/are provided. The reference distance information may be provided on the basis of the temporal occurrence of the pulsed detector signal with respect to the pulsed emission of the light radiations, and thus on the basis of a time of flight of the light radiations emitted in pulsed fashion and at least partly reflected back. The depth information may be provided on the basis of a pulse width of the pulsed detector signal.

In a further embodiment, the provision (carried out on the basis of phase information) of the distance information is carried out additionally taking account of the reference distance information or taking account of the reference distance information and the depth information. In this way, occurrence of ambiguities may be combated, and the distance information may be provided in an unambiguous manner.

In a further embodiment, the emitter is operated in such a way that joint radiation operation is performed in each case successively by different light source groups comprising a plurality of light sources. The joint radiation operation comprises a continuous operating mode or a continuous operating mode and a pulsed operating mode. In the continuous operating mode the light sources of the respective light source group emit differently modulated light radiations with different modulation frequencies. In the pulsed operating mode the light sources of the respective light source group emit light radiations in the form of at least one common pulse. As a result, together with an evaluation of detector signals generated by the detector, a high-resolution image representation of a target region may be provided.

The advantageous embodiments and developments of the invention explained above and/or presented in the dependent claims may be applied-apart from for example in cases of clear dependencies or incompatible alternatives-individually or else in any desired combination with one another.

The above-described properties, features and advantages of this invention and the way in which they are achieved will become clearer and more clearly understood in association with the following description of exemplary embodiments which are explained in greater detail in association with the schematic drawings, in which:

FIG. 1 shows an illustration of a lidar system comprising an emitter, a detector and a control device;

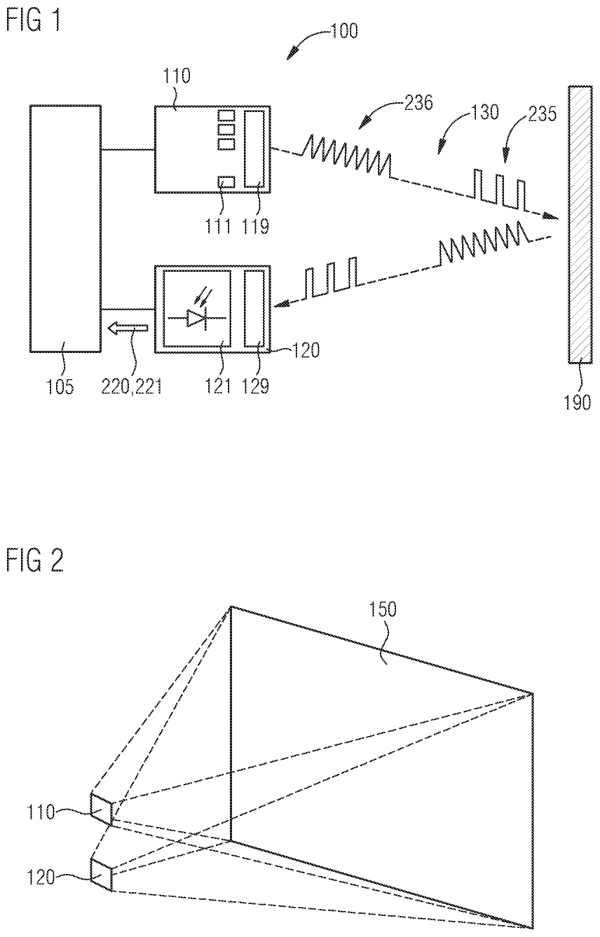

FIG. 2 shows a perspective illustration of the emitter and the detector and a detected target region;

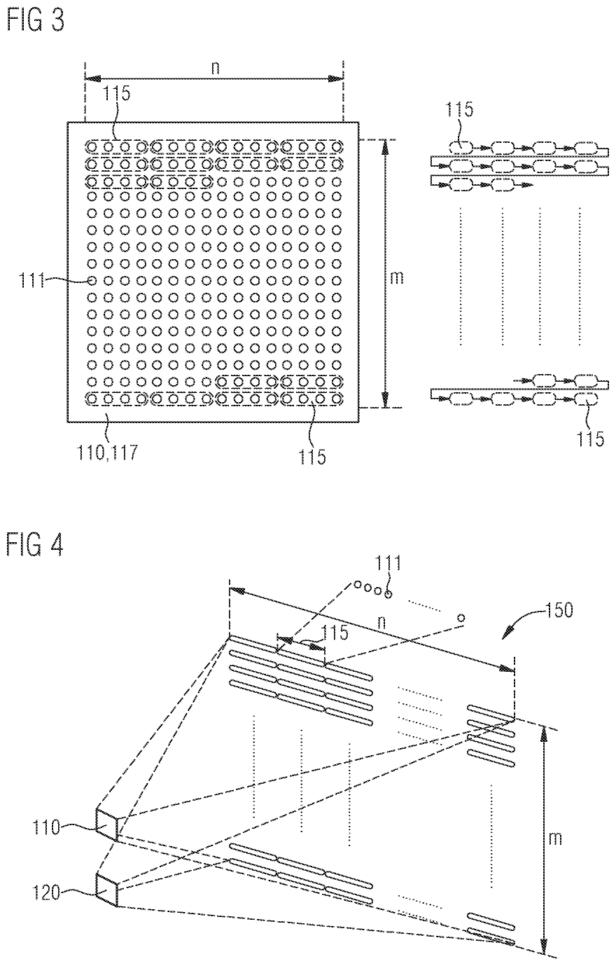

FIG. 3 shows a plan view illustration of a laser component of the emitter comprising a plurality of light sources and light source groups, including a diagram that elucidates a successive manner of operation of the light source groups;

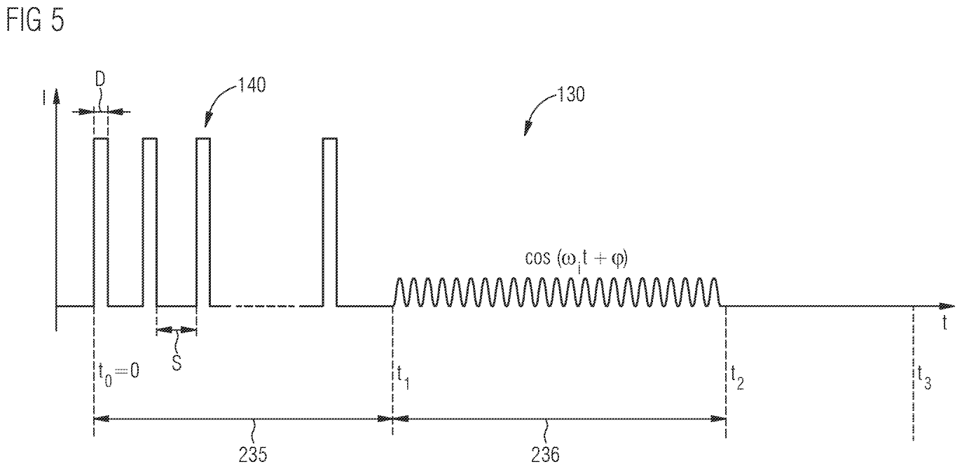

FIG. 4 shows a further perspective illustration of the emitter and the detector and light source groups projected into the target region;

FIG. 5 shows an illustration of an intensity profile of light radiation emitted by a light source in a pulsed operating mode and a continuous operating mode;

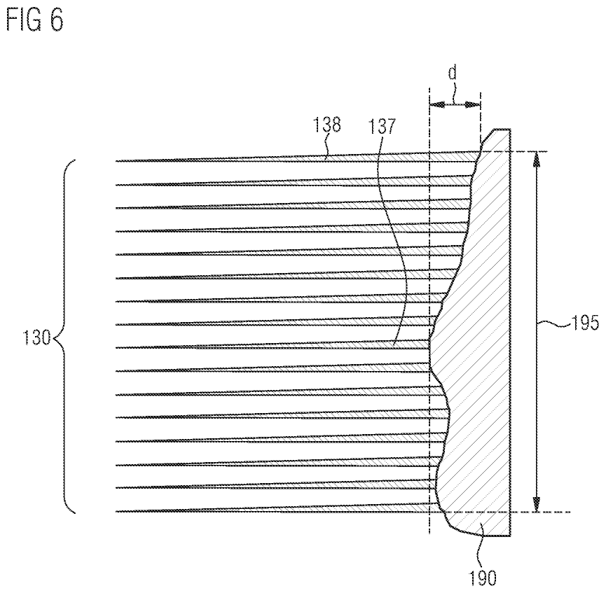

FIG. 6 shows an illustration of an irradiation of an object by a light source group;

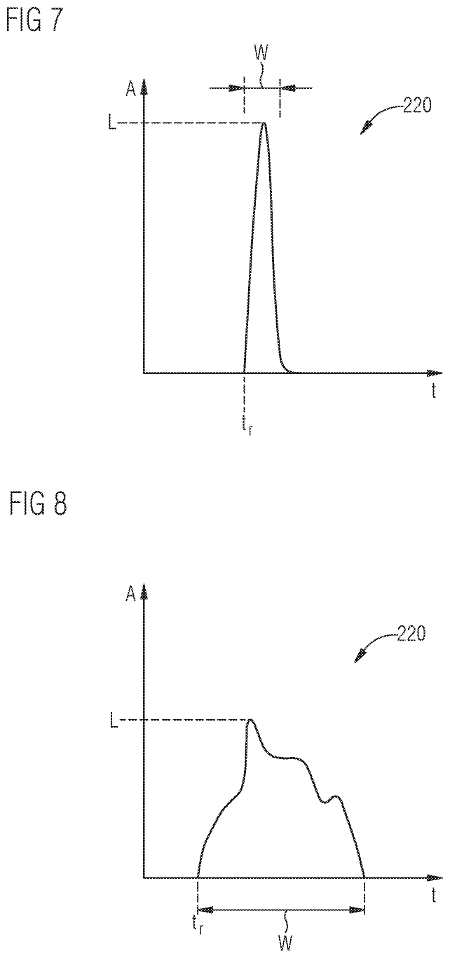

FIGS. 7 and 8 show illustrations of pulsed detector signals;

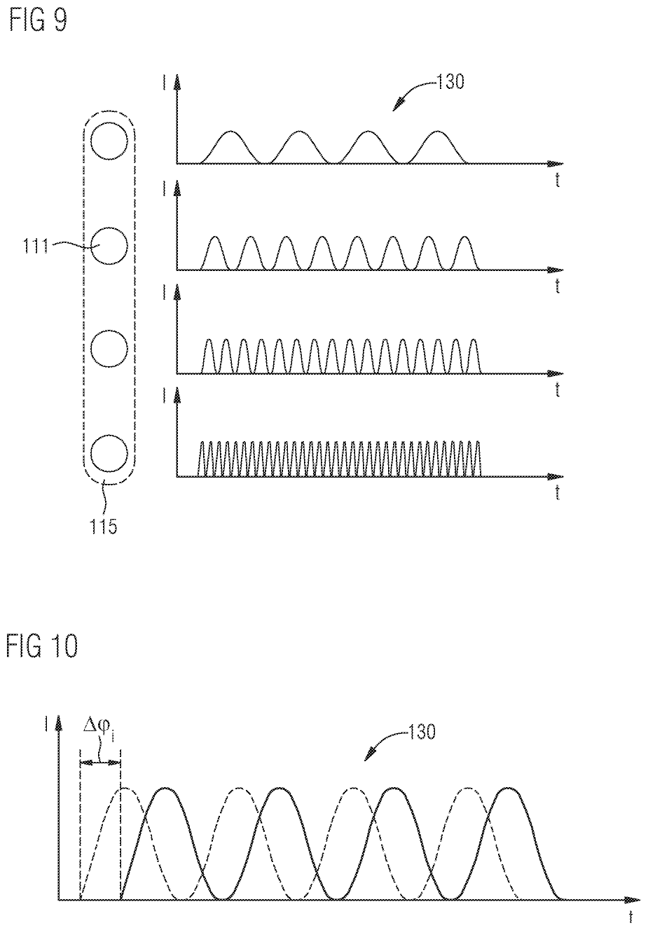

FIG. 9 shows an illustration of the intensity profiles of differently modulated light radiations emitted by the light sources of a light source group in the continuous operating mode;

FIG. 10 shows an illustration of the intensity profiles of phase-shifted light radiations;

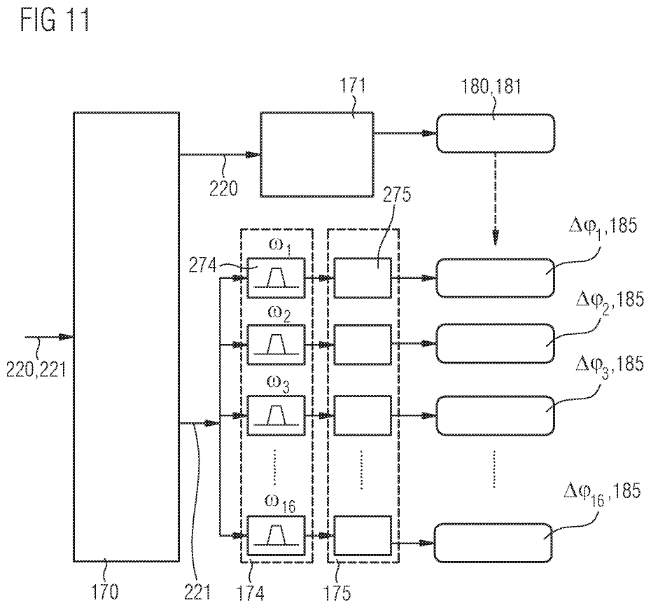

FIG. 11 shows an illustration of an evaluation of detector signals, with a frequency filtering being applied; and

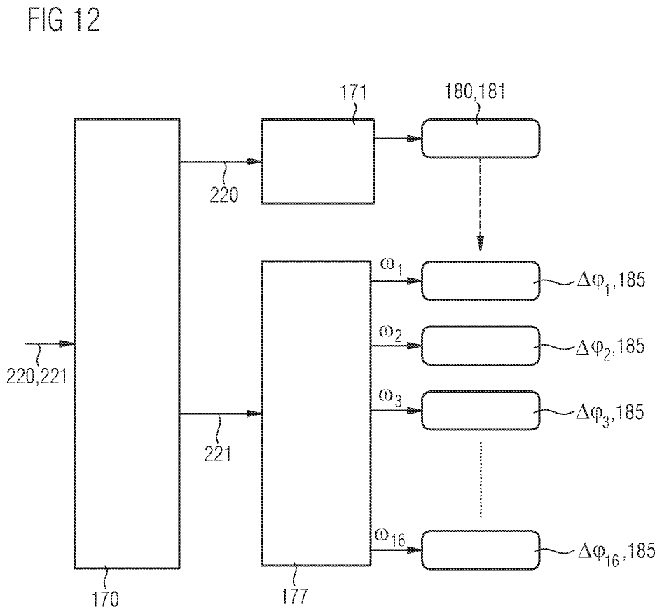

FIG. 12 shows an illustration of an evaluation of detector signals, with a Fourier transform being applied.

Configurations of a lidar system 100 (light detection and ranging) used for surroundings detection will be described on the basis of the schematic figures. With the aid of the lidar system 100, a target region 150 of interest may be optically scanned with a high resolution. The lidar system 100 may be applied for example in the automotive field, and here with regard to driver assistance systems or the field of autonomous driving.

FIG. 1 shows a schematic illustration of a lidar system 100. The lidar system 100 may be used in a motor vehicle (not illustrated) in order to be able to detect objects located in front of the vehicle and their distance from the vehicle. The lidar system 100 comprises an emitter 110 serving as an illumination source and configured for generating radiation, a detector 120 for radiation detection and a control device 105. The emitter 110 comprises a plurality of light sources 111 configured to emit light radiation 130. This may involve radiation in the infrared range or near infrared range. The light sources 111 of the emitter 110 may be controlled for light emission separately and thereby independently of one another.

FIG. 1 indicates that the light radiations 130 emitted by the light sources 111 during operation of the emitter 110, or a part of said light radiations, may be reflected at an object 190 and thereby reflected back in the direction of the lidar system 100 and the detector 120. The back-reflected light radiations 130 or a part thereof may be detected by the detector 120. On the basis thereof, the detector 120 may generate corresponding detector signals 220, 221. The term “back-reflection” used here may be a backscattering or may comprise a backscattering. The detector signals 220, 221 may be electrical signals such as voltage signals or current signals.

In the case of the lidar system 100, a relatively simply constructed detector 120 is used, which is realized in the form of a single detector comprising just a single radiation-sensitive detector structure. The detector structure may be realized with a large surface area, which fosters the detection of a back-reflected radiation portion. The detector 120 comprises a single photodiode 121 as radiation-sensitive detector structure. The photodiode 121 may be an avalanche photodiode (APD).

The control device 105 of the lidar system 100 serves for controlling the radiation operation of the emitter 110 and the light sources 111 thereof. The control device 105 may comprise corresponding driver circuits for this purpose. The control device 105 is furthermore used for the processing and evaluation of the detector signals 220, 221 generated by the detector 120. In this way, information such as distance information, for example in the form of a three-dimensional point cloud, may be provided by the control device 105. For this purpose, the control device 105 may comprise corresponding evaluation means or evaluation units.

As is shown in a perspective illustration in FIG. 2, a target region 150 may be optically detected with the aid of the lidar system 100. The target region 150 may also be referred to as observation region or field of view (FOV). The lidar system 100 is configured for this purpose such that the light radiations 130 generated by the light sources 111 of the emitter 110 may be emitted into different solid angle ranges of the target region 150, and the target region 150 may thereby be scanned in a raster-shaped fashion. If a back-reflection or backscattering occurs in the target region 150 illuminated in this way, the back-reflected light radiations 130, as described above, may be detected by the detector 120. The use of the emitter 110 comprising the plurality of light sources 111 affords the possibility of optically scanning the target region 150 with a high resolution.

The lidar system 100 may comprise further component parts besides the component parts mentioned above. For illuminating a target region 150 of interest, the lidar system 100 or the emitter 110 may comprise imaging optics 119 disposed downstream of the light sources 111 (cf. FIG. 1). With the aid of the imaging optics 119, each of the light sources 111 may be emitted into different solid angles and thereby projected onto different locations into the far field, with the result that, as described above, different solid angle ranges of the target region 150 may be illuminated. With regard to the detector 120, the lidar system 100 or the detector 120 may correspondingly comprise receiving optics 129. With the aid of the receiving optics 129, a back-reflected radiation portion may be collected and directed onto the photodiode 121 of the detector 120.

The light sources 111 of the emitter 110 may be realized in the form of lasers or semiconductor lasers, such that the light radiation 130 emitted by the light sources 111 is laser radiation. As is shown in a plan view illustration in FIG. 3, the emitter 110 may comprise a laser component 117 comprising the light sources 111. The laser component 117 may be a semiconductor or laser chip, on which the light sources 111 are arranged next to one another. The light sources 111, which may also be referred to as apertures or light-emitting pixels, may be configured in the form of surface emitters (VCSEL, vertical-cavity surface-emitting laser). In this sense, the emitter 110 may comprise an addressable VCSEL arrangement.

In accordance with the configuration shown in FIG. 3, the light sources 111 of the emitter 110 are arranged next to one another in matrix-like fashion in the form of rows and columns. In this way, an m×n arrangement comprising light sources 111 may be present, where m denotes a number of rows or row number and n denotes a number of columns or column number. In a departure from the configuration shown in FIG. 3 comprising sixteen rows and columns (16×16 arrangement), the emitter 110 may comprise a different or larger number of rows and columns, and hence a different or larger number of light sources 111. The number of light sources 111 may be in the five-digit range, for example. For this purpose, the emitter 110 and the laser component 117 may comprise for example a configuration comprising two hundred and fifty-six rows and columns (256×256 arrangement), and thus a total of 65536 light sources 111.

During operation of the lidar system 100, provision is made for the emitter 110 to be controlled by the control device 105 such that joint radiation operation is performed in a successive manner in the case of different groups comprising a plurality of light sources 111, referred to as light source groups 115. To put it another way, the emitter 110 is controlled in such a way that joint radiation operation is performed in each case successively by different light source groups 115 comprising a plurality of light sources 111.

In FIG. 3, in the case of the emitter 110 or laser component 117, a plurality of such light source groups 115 whose light sources 111 are in each case operated jointly and thereby simultaneously for radiation emission are indicated by dashed lines. In the present case, the light source groups 115 comprise a plurality of light sources 111 arranged next to one another along a row. In this case, the emitter 110 may be controlled in such a way that the successive joint radiation operation of the different light source groups 115 takes place proceeding from a first light source group 115 up to a last light source group 115 of the emitter 110.

In FIG. 3, a possible procedure is indicated in a diagram to the right of the emitter 110 with the aid of arrows. In this case, the light source group 115 arranged on the left in the top first row constitutes a first light source group 115. After the joint radiation operation of light sources 111 of this light source group 115, the further light source groups 115 located to the right thereof in the same row are controlled successively, specifically in such a way that the light sources 111 belonging to a light source group 115 are in each case operated jointly. Afterward, the light source groups 115 in the second row located underneath are controlled successively, and likewise from left to right, in such a way that there is in each case joint radiation operation for these light source groups 115. This process is continued row by row for the rows respectively located underneath until the bottommost last row comprising light source groups 115 is reached. In this case, the light source group 115 arranged on the right in this row constitutes a last light source group 115 with respect to the successively performed operation of light source groups 115 of the emitter 110.

By way of the successive control of the light source groups 115, which may also be referred to as a sequential flash method, with the aid of the lidar system 100 or by way of carrying out an evaluation by the control device 105 on the basis of detector signals 220, 221 generated by the detector 120, a three-dimensional image representation of a target region 150, for example in the form of a point cloud, may be provided progressively. In this case, the target region 150 may be optically detected step by step in the form of a high-resolution raster. The control of the light source groups 115 proceeding from a first light source group 115 up to a last light source group 115 may furthermore be carried out a number of times successively with a predefined repetition frequency. The repetition frequency, which may also be referred to as frame rate, may be in the two-digit Hz range, for example, and may be twenty-five or thirty hertz, for example.

In accordance with the illustration in FIG. 3, the light source groups 115 each comprise four light sources 111. In a departure therefrom, and with reference to the abovementioned configuration of the emitter 110 with a 256×256 arrangement comprising light sources 111, the light source groups 115 may comprise a different or larger number of light sources 111 arranged next to one another along a row, for example sixteen light sources 111. In the case of the configuration of the emitter 110 with a 256×256 arrangement comprising light sources 111, the operation of the emitter 110 may be carried out in this case with 4096 successively controlled light source groups 115. Such a configuration is indicated in the perspective illustration in FIG. 4, which elucidates optical image representations of a plurality of light source groups 115 projected into a target region 150.

With regard to the joint radiation operation of light sources 111 of individual light source groups 115, in the case of the lidar system 100, provision is furthermore made for the control of the emitter 110 that is performed by the control device 105 to be effected in such a way that the joint radiation operation comprises a pulsed operating mode 235 and a continuous operating mode 236 successively for each of the light source groups 115. As is indicated in FIG. 1, in the pulsed operating mode the light sources 111 of a light source group 115 emit light radiations 130 in the form of a plurality of successive common pulses or intensity pulses. The pulsed operating mode 235 may therefore also be referred to as a pulse mode.

In the continuous operating mode 236, which may also be referred to as a CW (continuous wave) operating mode, and which takes place after the pulsed operating mode 235, the light sources 111 of a light source group 115 emit light radiations 130 with a periodically modulated intensity. In this case, provision is further made for the light sources 111 of a light source group 115 to generate differently modulated light radiations 130 with modulation frequencies that differ from one another (cf. FIG. 9). In the continuous operating mode 236, light may be emitted by a light source group 115 in a continuous manner for a predefined time duration. According to the sine curve used to illustrate the continuous operating mode 236 in FIG. 1 (and also FIGS. 5, 9, 10), the periodically changing intensity of a modulated light radiation 130 may comprise the shape of a sine or cosine curve.

In order to elucidate the two operating modes 235, 236, FIG. 5 shows a diagram with an intensity profile of an intensity I as a function of time t for light radiation 130 such as may be emitted by a light source 111 of the emitter 110 in the joint radiation operation of a light source group 115. This illustration, and also the following description, may be applied in relation to all the light sources 111 and light source groups 115 of the emitter 110.

In the pulsed operating mode 235 extending from a point in time t₀=0 to a point in time t₁, the light radiation 130 of a light source 111 is emitted in the form of a plurality of successive pulses 140. With regard to the associated light source group 115, the pulsed light emission in the operating mode 235 takes place in each case jointly and at the same time, such that light radiations 130 in the form of a plurality of successive common radiation pulses 140 are emitted by all the light sources 111 of the light source group 115. In the case of a back-reflection, at least a part of the light radiations 130 emitted in pulsed fashion a number of times in joint form may be detected with the aid of the detector 120, whereby the detector 120 may successively generate a plurality of pulsed detector signals 220 (cf. FIGS. 1, 7, 8). By way of an evaluation of the pulsed detector signals 220, which is performed by the control device 105, distance information 180 serving as reference and used for comparison, and referred to hereinafter as reference distance information 180, and depth information 181 may be provided (cf. FIGS. 11, 12).

The number of radiation pulses 140 emitted successively by a light source group 115 in the pulsed operating mode 235 may be in the two-digit range, and may be fifty, for example. The light emission in the form of a plurality of pulses 140 serves to attain an improvement in the signal-to-noise ratio (SNR) during the operation of the lidar system 100. The aforementioned provision of the reference distance information 180 and the depth information 181 may be effected on the basis of the plurality of pulsed detector signals 220 generated by the detector 120. In this case, the evaluation carried out by the control device 105 may comprise summing the detector signals 220, and ascertaining the respective items of information 180, 181 using the summed detector signals 220. This procedure makes it possible to suppress noise contributions that may affect the detector signals 220.

In the continuous operating mode 236 extending from the point in time t₁ to a point in time t₂, as shown in FIG. 5, the light radiation 130 of a light source 111 is emitted with a periodically modulated intensity I. With regard to the associated light source group 115, the modulated light emission in the operating mode 236 takes place in each case jointly and at the same time, such that modulated light radiations 130 are emitted by all the light sources 111 of the light source group 115. In this case, each of the light sources 111 of the light source group 115 emits its light radiation 130 with a dedicated modulation frequency that differs from the modulation frequencies of the other light sources 111 (cf. FIG. 9). As has been indicated above and is shown in FIG. 5, the periodically changing intensity may comprise the shape of a sine or cosine curve. In FIG. 5, this circumstance is additionally identified by the term cos (ωᵢt+φ), where ωᵢ denotes the respective modulation frequency and φ denotes a phase.

In the case of a back-reflection, at least a part of the differently modulated light radiations 130 emitted in joint form may be detected with the aid of the detector 120, whereby the detector 120 may generate a modulated detector signal 221 (cf. FIG. 1). By way of an evaluation of the modulated detector signal 221, which is performed by the control device 105, with regard to each of the detected and differently modulated light radiations 130, phase information Δφ and, on the basis thereof, distance information 185 may be provided (cf. FIGS. 11, 12).

FIG. 5 furthermore illustrates a further point in time t₃ located after the point in time t₂. Until the point in time t₃ the return of the differently modulated light radiations 130 emitted in the continuous operating mode 236 is expected or awaited in order to detect this radiation portion using the detector 120. Starting from the point in time to the joint radiation operation of a further light source group 115 of the emitter 101 is performed in the two operating modes 235, 236, wherein the detector signals 220, 221 generated by the detector 120 in the case of a back-reflection are once again evaluated by the control device 105.

With regard to the pulsed operating mode 235, a pulse duration D of the radiation pulses 140 is illustrated in FIG. 5, and may be 10 ns. A time interval S which is present between successive pulses 140 and in which no light is emitted is furthermore illustrated. Maintaining the time interval S between the pulses 140 serves to enable separate generation of pulsed detector signals 220 associated with different pulses 140, or, to put it another way, to avoid temporally overlapping detection—by the detector 120—of light radiations 130 that are emitted by different pulses 140 and are reflected back. The time interval S may depend on an expected or predefined maximum depth extent of an object in an irradiation region that is jointly illuminated by light sources 111 of a light source group 115.

For explanation purposes, FIG. 6 shows an irradiation of an object 190 by a light source group 115—comprising sixteen light sources 111—of the emitter 110 in the pulsed operating mode 235. The light radiations 130 emitted by the light sources 111 are illustrated in the form of light beams running parallel. This circumstance may be present approximately in the vicinity of the object 190. The illumination of the object 190 by the light source group 115 takes place in an irradiation region 195. In the irradiation region 195, the object 190 comprises a surface profile comprising a depth extent d that is different than zero. This circumstance has the effect that the light radiations 130 reflected at the object 190 reach the detector 120 at different points in time and may thus comprise different times of flight. In FIG. 6, in this regard, a light beam for which the reflection occurs at a location of the object 190 at the shortest distance and hence first, and the shortest time of flight is therefore present, is provided with the reference sign 137. Furthermore, a further light beam for which the reflection occurs at a location of the object 190 at the largest distance and hence last, and the longest time of flight is therefore present, is provided with the reference sign 138.

The pulsed irradiation of an object 190 comprising a depth extent d, as is illustrated by way of example in FIG. 6, results in a maximum time difference Δt—relating to the unit of nanoseconds—between the reflected-back light radiations 130 reaching the detector 120 of

$$Δ t = 2 d * 3.3 [ ns ] = 6.6 d [ ns ] . \qquad ( 1 )$$

In this case, d is the depth extent established in the unit of meters, the factor 2 relates to the emission and back-reflection of the light radiations 130, and the factor 3.3 relates to the propagation of the light radiations 130 that takes place at the speed of light, i.e. the light radiations 130 require a time of 3.3 ns for a path distance of 1 m.

Separate generation of pulsed detector signals 220 associated with different radiation pulses 140 may accordingly be made possible by virtue of the time interval S illustrated in FIG. 5 corresponding to at least the sum of the time difference Δt and the pulse duration D, and the following thus holding true:

$$S > 6.6 d + D [ ns ] \qquad ( 2 )$$

Given a predefined maximum depth extent of, for example, d=5 m and a pulse duration D=10 ns, (at least) 43 ns may accordingly be established as the time interval S. By way of applying an additional off time duration of a further 20 ns, and for provision of fifty radiation pulses 140, there holds true for the point in time t₁=50*(43 ns+20 ns)=3.15 μs.

In the continuous operating mode 236 performed subsequently, the modulated light emission may be effected for a time duration of 2.5 μs, such that there holds true for the point in time t₂=5.65 μs. The remaining time duration until the point in time t₃ may be established as more than 1 μs, such that the point in time t₃ may be in a range of 7 μs to 7.3 μs, for example. In the case of the abovementioned configuration of the emitter 110 with a 256×256 arrangement comprising light sources 111 and the number of 4096 successively controlled light source groups 115, the scanning of a target region 150 may therefore take place with a time duration in the range of 30 ms.

The pulsed detector signals 220 generated successively by the detector 120 of the lidar system 100 in the pulsed operating mode 235 of a light source group 115 in the case of a back-reflection may have been formed by a superimposition of the detected light radiations 130 previously emitted in pulsed fashion, and may accordingly reproduce a superimposition of these light radiations 130. As has been explained above with reference to FIG. 6, different times of flight of the light radiations 130 emitted jointly by a light source group 115 in the pulsed operating mode 235 may occur on account of the surface profile of an irradiated object. The surface shape therefore has an influence on the appearance of the detector signals 220 generated by the detector 120.

For explanation purposes, FIG. 7 illustrates a pulsed detector signal 220 such as may be generated by the detector 120 upon detection of light radiations 130 emitted in the form of a pulse 140 by a light source group 115 and reflected back at an object. FIG. 7 shows, on the basis of a diagram, a possible profile of an amplitude A of the detector signal 220 as a function of time t for the case of an irradiation of an object comprising a flat surface, in the case of which, in a departure from FIG. 6, a depth extent of zero, i.e. d=0, is present. This circumstance may have the consequence that the light radiations 130 emitted in pulsed fashion and reflected back reach the detector 120 (substantially) at the same time and without any (appreciable) time delay with respect to one another, and the individual light intensities are therefore superimposed (substantially) simultaneously. As a result, the detector signal 220 may comprise a relatively narrow pulse width W and a relatively large maximum amplitude level L. The pulse width W may correspond to the pulse duration D of a radiation pulse 140, and may be 10 ns or in the range of 10 ns.

For comparison purposes, FIG. 8 depicts a further pulsed detector signal 220 on the basis of a time-dependent profile of the amplitude A, such as may be generated in the case of a pulsed irradiation of an object comprising an inhomogeneous or else curved surface profile, and consequently comprising a depth extent of d>0, with the aid of the detector 120 in the case of a back-reflection. This may have the effect that the light radiations 130 emitted in pulsed fashion by a light source group 115 and reflected back comprise different delay times or times of flight, and therefore reach the detector 120 at different times. The detector signal 220 generated by the superimposition of these light radiations 130 by the detector 120, or the shape of said signal, may be highly dependent on the surface profile of the irradiated object. In contrast to the detector signal 220 shown in FIG. 7, the detector signal 220 in FIG. 8 may furthermore comprise a greater pulse width W. In this case, the pulse width W may correspond to the sum of the time difference Δt indicated in formula (1) and the pulse duration D of a radiation pulse 140, i.e.

$$W = Δ t + D [ ns ] = 6.6 d + D [ ns ] . \qquad ( 3 )$$

Furthermore, in contrast to FIG. 7, a smaller amplitude level L may be present on account of the light radiations 130 reflected back to the detector 120 at different times.

FIGS. 7 and 8 furthermore indicate a reception time tᵣ which relates to a time duration beginning with the emission of the light radiations 130 of a light source group 115 in the form of a common pulse 140 and the (beginning) reception of an associated back-reflected radiation portion by the detector 120, and which therefore constitutes a time of flight. The time of flight is dependent on the path distance covered by the light radiations 130, and thus on the distance of an object at which the light radiations 130 may be reflected back.

In the context of the evaluation carried out by the control device 105 of the system 100, accordingly on the basis of the pulsed detector signals 220, i.e. a temporal occurrence of the detector signals 220 with respect to the respectively associated pulsed light emission from a light source group 115, a time of flight may be ascertained and, on the basis thereof and taking account of the speed of light, information about the path distance covered and thus about the distance of a back-reflecting object and consequently, as already indicated above, reference distance information 180 may be provided (cf. FIGS. 11 and 12). In this sense a direct approach in the form of a direct time of flight (direct TOF) measurement is employed in order to determine the reference distance information 180. In the event of different times of flight, as is the case for the detector signal 220 shown by way of example in FIG. 8, for example the smallest distance associated with the shortest time of flight (i.e. the reception time tᵣ) may be employed as reference distance information 180. It is also possible for an average distance obtained by averaging to be used as reference distance information 180. In this case, an average time of flight may be formed from different times of flight, and the average distance may be ascertained on the basis thereof.

Alternatively, different distance values may be ascertained on the basis of different times of flight, and the average distance may be obtained by averaging. The reference distance information 180 relates to the light emission of a light source group 115, and thus to an irradiation region comprising a plurality of solid angle ranges (cf. the region 195 in FIG. 6).

Since the pulse width W of the pulsed detector signals 220 furthermore depends on the depth extent d of a surface of an irradiated object, it is possible, in the course of the evaluation carried out by the control device 105, directly to provide information about that and thus, as already indicated above, depth information 181 (cf. FIGS. 11 and 12). The depth information 181 in relation to the extent d may be ascertained on the basis of the pulse width W respectively present, and using formula (3) solved with respect to d.

With regard to the summing of the pulsed detector signals 220 that is carried out in order to improve the signal-to-noise ratio, as has been explained above, the reference distance information 180 and the depth information 181 may be provided by the control device 105 on the basis of the summed detector signals 220.

In the continuous operating mode 236, the light sources 111 of a light source group 115, as indicated above, jointly emit differently modulated light radiations 130 with different modulation frequencies. The modulation frequency relates to the periodic change in the light intensity, which may take place sinusoidally or cosinusoidally. Each of the light sources 111 of the light source group 115 emits its light radiation 130 with a specific modulation frequency that differs from the modulation frequencies of the other light sources 111 of the light source group 115. The number of differently modulated light radiations 130 emitted by a light source group 115 therefore corresponds to the number of light sources 111 of the light source group 115. The maximum intensity of the emitted light radiations 130 may be the same in each case.

In order to elucidate this circumstance, FIG. 9 shows time-dependent intensity profiles of four differently modulated light radiations 130 such as may be jointly emitted by four light sources 111 of a light source group 115 of the emitter 110 in the continuous operating mode 236. As has been indicated above, a different or larger number of light sources 111, for example sixteen light sources 111, may be conceivable for the successively controlled light source groups 115 of the emitter 110. In this respect, a different or larger number of differently modulated light radiations 130, i.e. for example sixteen differently modulated light radiations 130, may be jointly emitted by such a light source group 115. For the control of the emitter 110 comprising the successively operated light source groups 115, the same different modulation frequencies may be employed in each case for each of the light source groups 115 in the continuous operating mode 236.

The modulated detector signal 221 generated by the detector 120 of the lidar system 100 in the continuous operating mode 236 of a light source group 115 in the case of a back-reflection may have been formed by a superimposition of the detected and differently modulated light radiations 130, and may accordingly reproduce a superimposition of these light radiations 130. The detector signal 221 may comprise a temporally changing or modulated amplitude, wherein the temporal change in the amplitude may take place according to the superimposition of the differently modulated light radiations 130 (not illustrated).

In the context of the evaluation of such a modulated detector signal 221 that is carried out by the control device 105, the different modulation frequencies make it possible to attain a separation with regard to the differently modulated light radiations 130 and thus to consider the latter separately. For this purpose, a frequency filtering or Fourier transform of the detector signal 221 may be performed by the control device 105, as is explained further below with reference to FIGS. 11 and 12.

In this context, the modulation frequencies are chosen such that a reliable separation in regard to the differently modulated light radiations 130 is possible during the evaluation. The modulation frequencies may be in the MHz range, for example. They may be multi-digit MHz frequencies. The modulation frequencies used may differ from one another in each case by 50 MHz, for example, such that modulation frequencies of, for example, 50 MHz, 100 MHz, 150 MHz, 200 MHz, etc. may be used.

With regard to the evaluation concerning the continuous operating mode 236, in a departure from the pulsed operating mode 235, an indirect approach in the form of an indirect time of flight (indirect TOF) measurement is pursued. In this case, with respect to each of the detected and differently modulated light radiations 130, phase information in the form of a phase shift Δφ and, on the basis thereof, distance information 185 are ascertained by the control device 105.

For elucidation purposes, FIG. 10 shows a diagram with possible time-dependent intensity profiles of a modulated light radiation 130 upon emission by a light source 111 of the emitter 110 (solid line) and after a back-reflection at an object upon reception by the detector 120 (dashed line). In a departure from the schematic illustration in FIG. 10, the intensity of the back-reflected light radiation 130 may be lower than that of the emitted light radiation 130. The emitted and reflected light radiation 130 comprise a phase shift Δφᵢ with respect to one another. The phase shift Δφᵢ, besides being dependent on the speed of light and the respective modulation frequency ωᵢ, is dependent on the path distance covered and thus on the distance of the object that reflects back the light radiation 130. With the aid of an evaluation on the basis of the phase shift Δφᵢ, distance information 185 may consequently be obtained (cf. FIGS. 11 and 12).

With regard to the light emission of a light source group 115 in the continuous operating mode 236, on the basis of a modulated detector signal 221 generated by the detector 120 (depending on the number of back-reflected light radiations 130), for at least one or a plurality or each of the back-reflected and differently modulated light radiations 130 comprised by the detector signal 221, phase information Δφᵢ and associated distance information 185 may be provided by the control device 105. In this case, for example, the phase angles of the respectively emitted light radiations 130 to which the items of phase information or phase shifts Δφᵢ are respectively related may be known on account of the control of the relevant light sources 111 that is performed by the control device 105, or may be determined in some other suitable manner. As has been explained above, the light radiations 130 of the light sources 111 of the emitter 110 may be emitted into different solid angle ranges of a target region 150 (cf. FIG. 4). Accordingly, it is possible to provide dedicated phase information Δφᵢ and distance information 185 in each case for different solid angle ranges. The distance information 185 may relate here to a specific spatial point or region of a back-reflecting object.

In the case of the indirect approach of providing distance information 185 on the basis of phase information Δφᵢ, an ambiguity may occur on account of the periodicity of the modulated light radiations 130 used. In this case, there is the possibility of ascertaining a plurality of different distance values on the basis of the phase information Δφᵢ.

For the evaluation of a modulated detector signal 221 generated in the continuous operating mode 236 of a light source group 115, the evaluation being carried out by the control device 105, provision is therefore made for carrying out the provision of the phase information (items) Δφᵢ and distance information (items) 185 additionally taking account of the reference distance information 180 obtained in the preceding pulsed operating mode 235 of the same light source group 115, and optionally the depth information 181. These items of information 180, 181 may be unambiguous on account of the direct approach used for determining them and may thus be used for comparison in order to determine distance information 185 associated with phase information Δφᵢ in an unambiguous manner. Further distance values which, although they may be appropriate to the phase information Δφᵢ, are irreconcilable with the reference distance information 180 and, if appropriate, the depth information 181 may be disregarded as a result.

FIG. 11 elucidates, in a diagram, a possible implementation of an evaluation by the control device 105 of the lidar system 100, with a frequency filtering being applied. The evaluation is performed on the basis of detector signals 220, 221 generated by the detector 120 in the joint radiation operation of a light source group 115. As indicated above, the radiation operation comprises a pulsed operating mode 235, whereby pulsed detector signals 220 may be generated, and a continuous operating mode 236, whereby a modulated detector signal 221 may be generated. The control of the light source group 115 in the different operating modes 235, 236 is effected temporally successively, which correspondingly applies to the generation of the respective detector signals 220, 221. This enables a temporal separation 170 with respect to processing and evaluation of the detector signals 220, 221 by the control device 105.

For the pulsed detector signals 220, use is made of a direct time of flight analysis 171 with the aim, as explained above, of providing reference distance information 180 and optionally depth information 181. The reference distance information 180, according to the pulsed light emission effected by the light sources 111 of the relevant light source group 115, relates to an irradiation region comprising a plurality of solid angle ranges.

A separate evaluation in regard to the differently modulated light radiations 130 is employed for the modulated detector signal 221. A filtering 174 of the detector signal 221 that is tuned to the different modulation frequencies ωᵢ is carried out for this purpose. As is indicated in FIG. 11, for this purpose the control device 105 may comprise bandpass filters 274 which are tuned to the modulation frequencies ωᵢ and by which the filtering 174 of the detector signal 221 may be performed. According to the above-described configuration of a light source group 115 comprising sixteen light sources 111 and a use of sixteen modulation frequencies ω₁ to ω₁₆ corresponding thereto, the bandpass filtering is effected for each of the sixteen modulation frequencies ω₁ to ω₁₆.

The detector signal 174 decomposed into different frequency components that is present after the filtering 174 is subsequently subjected to a phase detection 175 with the aim of providing phase information Δφᵢ and, on the basis thereof, distance information 185 as explained above for the back-reflected and differently modulated light radiations 130. The phase detection 175 for outputting the items of phase information Δφᵢ may be carried out with the aid of phase detectors 275—indicated in FIG. 11—or phase comparators of the control device 105. With regard to the sixteen modulation frequencies ω₁ to ω₁₆ it is possible to provide in this way (depending on the number of back-reflected light radiations 130 up to) sixteen items of phase information Δφ₁ to Δφ₁₆ and, on the basis thereof, (up to) sixteen items of distance information 185. In order to be able to provide the items of distance information 185 in an unambiguous manner, this step takes place additionally taking account of the reference distance information 180 provided by the time of flight analysis 171, and optionally the depth information 181. An item of distance information 185 determined in this way relates to the modulated light radiation 130 emitted by a light source 111 of the light source group 115, and thus to an individual solid angle range.

A Fourier transform may be used as an alternative to the frequency filtering. For elucidation purposes, FIG. 12 shows, in a diagram, a further possible procedure such as may be considered for the evaluation performed by the control device 105. The evaluation is effected on the basis of detector signals 220, 221 generated by the detector 120 in the joint radiation operation of a light source group 115. The successively performed operating modes 235, 236 enable a temporal separation 170 in regard to processing and evaluation of the detector signals 220, 221. For the pulsed detector signals 220 generated in the pulsed operating mode 235 of the light source group 115, a direct time of flight analysis 171 is used in order to provide reference distance information 180 and optionally depth information 181. The reference distance information 180 relates to an irradiation region comprising a plurality of solid angle ranges.

The modulated detector signal 221 generated in the continuous operating mode 236 of the light source group 115 is subjected to a Fourier analysis 177 with the aim of separately considering the back-reflected and differently modulated light radiations 130 and, as indicated above, providing phase information Δφᵢ and, on the basis thereof, distance information 185. A Fourier transform of the modulated detector signal 221 in the frequency domain is carried out in the course of the Fourier analysis 177. This may involve a fast Fourier transform (FFT). In this case, the modulated detector signal 221 is decomposed or divided into different frequency components, which makes it possible to provide associated phase information Δφᵢ for the differently modulated light radiations 130. The Fourier analysis 177 may be carried out with the aid of an analyzer or FFT analyzer of the control device 105. According to the sixteen modulation frequencies ω₁ to ω₁₆ it is possible to provide (depending on the number of back-reflected light radiations 130 up to) sixteen items of phase information Δφ₁ to Δφ₁₆ and, on the basis thereof, (up to) sixteen items of distance information 185. In order to provide the items of distance information 185 in an unambiguous manner, this step is carried out additionally taking account of the reference distance information 180 and optionally the depth information 181. An item of distance information 185 determined in this way relates to an individual solid angle range.

As has been explained above, the emitter 110 is controlled by the control device 105 during operation of the lidar system 100 in such a way that in each case successively from different light source groups 115 comprising a plurality of light sources 111 there is a joint light emission in the pulsed operating mode 235 and in the continuous operating mode 236. In the process, the light sources 111 illuminate different solid angle ranges of a target region 150 (cf. FIGS. 3 and 4). The detector signals 220, 221 generated by the detector 120 in the case of a back-reflection are evaluated by the control device 105, whereby inter alia items of distance information 185 concerning different solid angle ranges of the target region 150 may be obtained (cf. FIGS. 11 and 12). The target region 150 may thereby be optically scanned in the form of a raster with a high spatial resolution. An image representation of the target region 150, for example in the form of a three-dimensional point cloud, may be generated on the basis of the information provided by the control device 105.

Besides the embodiments described above and depicted in the figures, further embodiments are conceivable which may comprise further modifications and/or combinations of features.

In this sense, numerical indications above should be regarded merely as examples which may be replaced by other indications. This applies for example to modulation frequencies used, to a number of light sources 111 of the emitter 110, to a number of light sources 111 per light source group 115, to a number of different modulation frequencies, and to time indications.

With regard to control of light source groups 115, one possible modification consists in providing therefor a different arrangement comprising jointly operated light sources 111. Instead of light sources 111 arranged next to one another in a series, other arrangements may be conceivable for the light source groups 115, for example matrix arrangements comprising light sources 111 in the form of rows and columns. One example is an arrangement comprising sixteen light sources 111 in the form of four rows and columns (4×4 arrangement).

A further possible modification consists in performing the operating modes 235, 236 in the joint radiation operation of a light source group 115 in the opposite order, i.e. first the continuous operating mode 236 and subsequently the pulsed operating mode 235.

Although the invention has been more specifically illustrated and described in detail using preferred exemplary embodiments, nevertheless the invention is not restricted by the examples disclosed and other variations may be derived therefrom by a person skilled in the art, without departing from the scope of protection of the invention.

### LIST OF REFERENCE SIGNS

100 Lidar system
105 Control device
110 Emitter
111 Light source
115 Light source group
117 Laser component
119 Imaging optics
120 Detector
121 Photodiode
129 Receiving optics
130 Light radiation
137 Light beam
138 Light beam
140 Pulse
150 Target region
170 Separation
171 Time-of-flight analysis
174 Filtering
175 Phase detection
177 Fourier analysis
180 Reference distance information
181 Depth information
185 Distance information
190 Object
195 Irradiation region
220 Detector signal
221 Detector signal
235 Pulsed operating mode
236 Continuous operating mode
274 Bandpass filter
275 Phase detector
A Amplitude
d Depth extent
D Pulse duration
I Intensity
L Amplitude level
m Number of rows
n Number of columns
t Time
t₀ Point in time
t₁ Point in time
t₂ Point in time
t₃ Point in time
tᵣ Reception time
S Time interval
W Pulse width
Δφ Phase shift
ω Modulation frequency

1. A lidar system for surroundings detection, comprising an emitter for radiation emission and a detector for radiation detection,
wherein the emitter comprises a plurality of separately controllable light sources for emitting light radiation,
wherein the lidar system is configured to operate the emitter in such a way that joint radiation operation is performed by a light source group comprising a plurality of light sources,
wherein the joint radiation operation of the light source group comprises a continuous operating mode, in which the light sources of the light source group emit differently modulated light radiations with different modulation frequencies, and
wherein the detector is realized in the form of a single detector comprising only one radiation-sensitive detector structure.

2. The lidar system according to claim 1,
wherein in the case of a back-reflection at least a part of the differently modulated light radiations is detectable with the aid of the detector and on the basis thereof a modulated detector signal is generable by the detector,
and wherein the lidar system is configured, on the basis of the modulated detector signal, to provide at least one item of phase information and, on the basis thereof, distance information.

3. The lidar system according to claim 2,
wherein the lidar system is configured to carry out the provision of the phase information by way of applying a Fourier transform of the modulated detector signal.

4. The lidar system according to claim 2,
wherein the lidar system is configured to carry out the provision of the phase information by way of applying a frequency filtering of the modulated detector signal.

5. The lidar system according to claim 1,
wherein the joint radiation operation of the light source group comprises a pulsed operating mode, in which the light sources of the light source group emit light radiations in the form of at least one common pulse.

6. The lidar system according to claim 5,
wherein in the case of a back-reflection at least a part of the light radiations emitted in the form of a pulse is detectable with the aid of the detector and on the basis thereof a pulsed detector signal is generable by the detector,
and wherein the lidar system is configured, on the basis of the pulsed detector signal, to provide reference distance information or reference distance information and depth information.

7. The lidar system according to claim 6,
wherein the lidar system is configured to carry out the provision of the reference distance information on the basis of a time of flight of the light radiations emitted in the form of a pulse and at least partly reflected back.

8. The lidar system according to claim 6,
wherein the lidar system is configured to carry out the provision of the depth information on the basis of a pulse width of the pulsed detector signal.

9. The lidar system according to claim 6,
wherein in the case of a back-reflection at least a part of the differently modulated light radiations is detectable with the aid of the detector and on the basis thereof a modulated detector signal is generable by the detector,
wherein the lidar system is configured, on the basis of the modulated detector signal, to provide at least one item of phase information and, on the basis thereof, distance information, and
wherein the lidar system is configured to carry out the provision of the distance information additionally taking account of the reference distance information or taking account of the reference distance information and the depth information.

10. The lidar system according to claim 1,
wherein the light sources are configured in the form of surface emitters.

11. The lidar system according to claim 1,
wherein the detector comprises one of the following:
a single photodiode; or
a single avalanche photodiode.

12. The lidar system according to claim 1,
wherein the modulation frequencies are in the MHz range.

13. The lidar system according to claim 1,
wherein the lidar system is configured to operate the emitter in such a way that joint radiation operation is performed in each case successively by different light source groups comprising a plurality of light sources,
wherein the joint radiation operation comprises a continuous operating mode or a continuous operating mode and a pulsed operating mode,
wherein in the continuous operating mode the light sources of the respective light source group emit differently modulated light radiations with different modulation frequencies, and
wherein in the pulsed operating mode the light sources of the respective light source group emit light radiations in the form of at least one common pulse.

14. A method for operating a lidar system,
wherein the lidar system comprises an emitter for radiation emission and a detector for radiation detection,
wherein the emitter comprises a plurality of separately controllable light sources for emitting light radiation,
wherein the emitter is operated in such a way that joint radiation operation is performed by a light source group comprising a plurality of light sources,
wherein the joint radiation operation of the light source group comprises a continuous operating mode, in which the light sources of the light source group emit differently modulated light radiations with different modulation frequencies, and
wherein the detector is realized in the form of a single detector comprising only one radiation-sensitive detector structure.

15. The method according to claim 14,
wherein in the case of a back-reflection at least a part of the differently modulated light radiations is detected with the aid of the detector and on the basis thereof a modulated detector signal is generated by the detector,
and wherein on the basis of the modulated detector signal at least one item of phase information and, on the basis thereof, distance information are provided.

16. The method according to claim 14,
wherein the joint radiation operation of the light source group comprises a pulsed operating mode, in which the light sources of the light source group emit light radiations in the form of at least one common pulse.

17. The method according to claim 16,
wherein in the case of a back-reflection at least a part of the light radiations emitted in the form of a pulse is detected with the aid of the detector and on the basis thereof a pulsed detector signal is generated by the detector,
and wherein on the basis of the pulsed detector signal reference distance information or reference distance information and depth information are provided.

18. The method according to claim 17,
wherein in the case of a back-reflection at least a part of the differently modulated light radiations is detected with the aid of the detector and on the basis thereof a modulated detector signal is generated by the detector,
wherein on the basis of the modulated detector signal at least one item of phase information and, on the basis thereof, distance information are provided, and
wherein the provision of the distance information is carried out additionally taking account of the reference distance information or taking account of the reference distance information and the depth information.

19. The lidar system according to claim 13,
wherein in the continuous operating mode the same different modulation frequencies are employed in each case for the different light source groups.

20. A lidar system for surroundings detection, comprising an emitter for radiation emission and a detector for radiation detection,
wherein the emitter comprises a plurality of separately controllable light sources for emitting light radiation,
wherein the lidar system is configured to operate the emitter in such a way that joint radiation operation is performed in each case successively by different light source groups comprising a plurality of light sources,
wherein the joint radiation operation comprises a continuous operating mode or a continuous operating mode and a pulsed operating mode,
wherein in the continuous operating mode the light sources of the respective light source group emit differently modulated light radiations with different modulation frequencies, and
wherein in the pulsed operating mode the light sources of the respective light source group emit light radiations in the form of at least one common pulse.
